(19) United States
(12) Patent Application Publication
(10) Pub. No.: US 2013/0077651 A1
(43) Pub. Date: Mar. 28, 2013

(54) WAFTER TESTING APPARATUS

(71) Applicant: Ki-bong LEE, Osan-si (KR)

(72) Inventor: Ki-bong LEE, Osan-si (KR)

(21) Appl. No.: 13/535,615

(22) Filed: Jun. 28, 2012

(30) Foreign Application Priority Data
Sep. 23, 2011 (KR) 10-2011-0096375

(51) Int. Cl. G01N 25/66

(52) U.S. Cl. 374/28

(57) ABSTRACT

A wafer testing apparatus includes a temperature controller for comparing a predetermined first dew point with a second dew point in a prober, and a dry air controller for controlling an amount of dry air supplied into the prober based on a comparison result of the temperature controller.

### CROSS-REFERENCE TO RELATED APPLICATIONS

This application claims the benefit of Korean Patent Application No. 10-2011-0096375, filed on Sep. 23, 2011, in the Korean Intellectual Property Office, the disclosure of which is incorporated herein in its entirety by reference.

### BACKGROUND

1. Field

Embodiments relate to a wafer testing apparatus that tests electrical performance of a wafer on which semiconductor chips are fabricated, and more particularly, to a wafer testing apparatus including a controller.

2. Description of the Related Art

A plurality of semiconductor chips may be formed on a wafer and may be applied to electronic products after the semiconductor chips are packaged. The electronic products may be used at a high temperature of 100 degrees Celsius or at a low temperature less than 0 degree Celsius according to an ambient environment. In order to prepare for these two cases, a semiconductor package is electrically tested at a high temperature and at a low temperature. However, since the semiconductor package may undergo several assembling operations, a time for assembling the semiconductor package may be long, and the manufacturing cost may be high. Thus, a defective semiconductor package may represent a great loss of time and manufacturing cost. In order to reduce such a loss of time and manufacturing cost, electrical die sorting (EDS) is performed on a wafer before semiconductor chips fabricated thereon are packaged so as to find defective semiconductor chips among the fabricated semiconductor chips in advance. Thus, any detected defective semiconductor chips are not packaged. Various tests, e.g., a low temperature test, a high temperature test, and a room temperature test, may then be performed on the wafer.

### SUMMARY

According to an embodiment, there is provided a wafer testing apparatus including a temperature controller for comparing a predetermined first dew point with a second dew point in a prober, and a dry air controller for controlling an amount of dry air supplied into the prober based on a comparison result of the temperature controller.

The temperature controller may compare the first dew point with the second dew point in real time.

The temperature controller may compare the first dew point with the second dew point in the prober in real time, the second dew point varying based on an amount of dry air controlled by the dry air controller.

The temperature controller may include a storage unit for storing the first dew point, an information input unit to which the second dew point is input, and an output unit for comparing the first dew point stored in the storage unit with the second dew point input to the information input unit, and for outputting a comparison result to the dry air controller.

The dry air controller may be configured such that when the first dew point is higher than the second dew point, the dry air controller controls an amount of dry air supplied into the prober to be decreased.

The dry air controller may be configured such that when the first dew point is lower than the second dew point, the dry air controller controls an amount of dry air supplied into the prober to be increased.

The dry air controller may be configured such that when the first dew point is equal to the second dew point, the dry air controller controls to maintain constant an amount of dry air supplied into the prober.

The wafer testing apparatus may further include a first pipe portion through which dry air flows into the dry air controller from an external device, and a second pipe portion through which dry air is supplied into the prober at an amount controlled by the dry air controller.

The wafer testing apparatus may further include a dehumidifier for dehumidifying dry air that flows into the dry air controller through the first pipe portion.

The wafer testing apparatus may further include a dew point meter unit that measures the second dew point, the dew point meter unit being formed inside or outside the prober.

According to an embodiment, there is provided a wafer testing apparatus including a temperature controller for comparing a predetermined first dew point with a second dew point that is measured in a prober or a third dew point that is measured in a loader, and a dry air controller for controlling an amount of dry air supplied into the prober or the loader based on a comparison result of the temperature controller.

The temperature controller may include a storage unit for storing the first dew point, an information input unit to which information regarding the second dew point or the third dew point is input, and an output unit for comparing the first dew point stored in the storage unit, with the second dew point or the third dew point input to the information input unit and outputting a comparison result to the dry air controller.

The dry air controller may be configured such that when the first dew point is higher than the second dew point, the dry air controller controls an amount of dry air supplied into the prober to be decreased, and when the first dew point is lower than the second dew point, the dry air controller controls the amount of dry air supplied into the prober to be increased, and when the first dew point is equal to the second dew point, the dry air controller controls the amount of dry air supplied into the prober to be constant.

The dry air controller may be configured such that when the first dew point is higher than the third dew point, the dry air controller controls an amount of dry air supplied to the loader to be decreased, and when the first dew point is lower than the third dew point, the dry air controller controls the amount of dry air supplied to the loader to be increased, and when the first dew point is equal to the second dew point, the dry air controller controls the amount of dry air supplied to the loader to be constant.

The temperature controller may compare the first dew point with the second dew point or the third dew point in real-time.

According to an embodiment, there is provided a wafer testing apparatus, including a test chamber, a dew point measuring unit that monitors a dew point inside the test chamber and provides a measured test chamber dew point value in real time, and a controller that controls an amount of dry air supplied into the test chamber according to the measured test chamber dew point value.

The controller may store a predetermined dew point value, compares the predetermined dew point value with the measured test chamber dew point value to provide a comparison result, and controls the amount of dry air supplied to the test chamber according to the comparison result.

The controller may control the amount of dry air supplied to the test chamber to be decreased when the predetermined dew point value is greater than the measured test chamber dew point value, to be increased when the predetermined dew point value is less than the measured test chamber dew point value and to remain constant when the predetermined dew point value equals the measured test chamber dew point value.

The wafer testing apparatus may further include a loading chamber, wherein the dew point measuring unit may further monitor a dew point inside the loading chamber to provide a measured loading chamber dew point value in real time, and the controller may independently control an amount of dry air supplied into the loading chamber according to a comparison of the measured loading chamber dew point value with the predetermined dew point value.

The controller may control the amount of dry air supplied to the loading chamber to be decreased when the predetermined dew point value is greater than the measured test chamber dew point value, to be increased when the predetermined dew point value is less than the measured loading chamber dew point value and to remain constant when the predetermined dew point value equals the measured loading chamber dew point value.

### BRIEF DESCRIPTION OF THE DRAWINGS

Features will become apparent to those of ordinary skill in the art by describing in detail exemplary embodiments with reference to the attached drawings in which:

FIG. 1 illustrates a block diagram of a structure of a wafer testing apparatus according to an exemplary embodiment;

FIG. 2 illustrates a block diagram of a controller of the wafer testing apparatus illustrated in FIG. 1;

FIG. 3 illustrates a block diagram of a temperature controller of the controller of the wafer testing apparatus illustrated in FIG. 1;

FIG. 4 illustrates a flowchart depicting a method of controlling dry air supplied to the wafer testing apparatus illustrated in FIG. 1 by using the controller, according to an exemplary embodiment;

FIG. 5 illustrates a graph showing an amount of dry air supplied to a prober of a wafer testing apparatus that does not include a controller, according to time;

FIG. 6 illustrates a graph showing an amount of dry air supplied to a prober of the wafer testing apparatus illustrated in FIG. 1; and

FIG. 7 illustrates a block diagram of a wafer testing system according to an exemplary embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope thereof to those skilled in the art.

In the drawing figures, the dimensions of layers and regions may be exaggerated for clarity of illustration. Like reference numerals refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. As used in the specification, the terms “and/or” include one among the items described above and one or more combinations thereof.

It will be understood that, although the terms first, second, third, etc. may be used herein to describe various elements, components, regions, layers, and/or sections, these elements, components, regions, layers, and/or sections should not be limited by these terms. These terms do not refer to a particular order, rank, or superiority and are only used to distinguish one element, component, region, layer, or section from another element, component, region, layer, or section. Thus, a first element, component, region, layer, or section discussed below could be termed a second element, component, region, layer, or section without departing from the teachings of the example embodiments. For example, a first element may be referred to as a second element, and similarly, a second element may be referred to as a first element without departing from the scope of protection.

It will be understood that when an element, such as a layer, a region, or a substrate, is referred to as being “on,” “connected to”, or “coupled to” another element, it may be directly on, connected to, or coupled to the other element or intervening elements may be present. In contrast, when an element is referred to as being “directly on,” “directly connected to”, or “directly coupled to” another element or layer, there are no intervening elements or layers present. This applies to interpretation of other expressions for describing the relationship between elements, i.e., “between ˜” and “directly between ˜”, or “adjacent to ˜” and “directly adjacent to ˜”.

Meanwhile, when an exemplary embodiment can be differently implemented, a function or an operation specified in a particular block may be performed differently from an order specified in a flowchart. For example, two continuous blocks may be substantially simultaneously performed, or blocks may be performed in a reverse order according to a related function or operation.

Hereinafter, exemplary embodiments will be described with reference to accompanying drawings schematically illustrating the embodiments. In the drawings, for example, illustrated shapes may be deformed according to fabrication technology and/or tolerances. Therefore, the exemplary embodiments are not limited to certain shapes illustrated in the present specification, and may include modifications of shapes caused in fabrication processes.

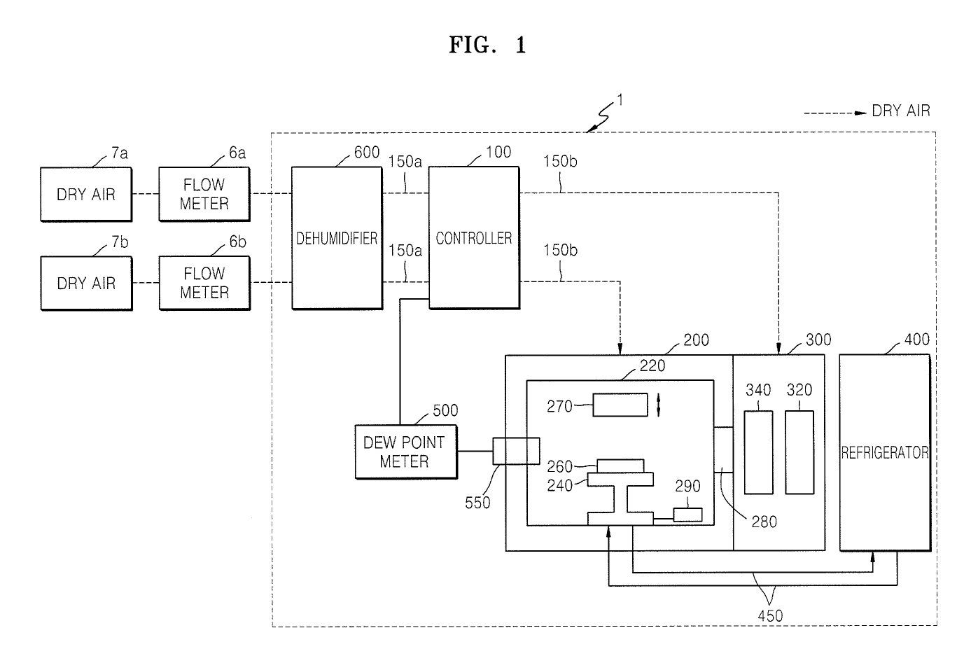

FIG. 1 illustrates a block diagram of a structure of a wafer testing apparatus 1 according to an exemplary embodiment. Referring to FIG. 1, the wafer testing apparatus 1 may include a controller 100, a prober 200, a loader 300, and a refrigerator 400.

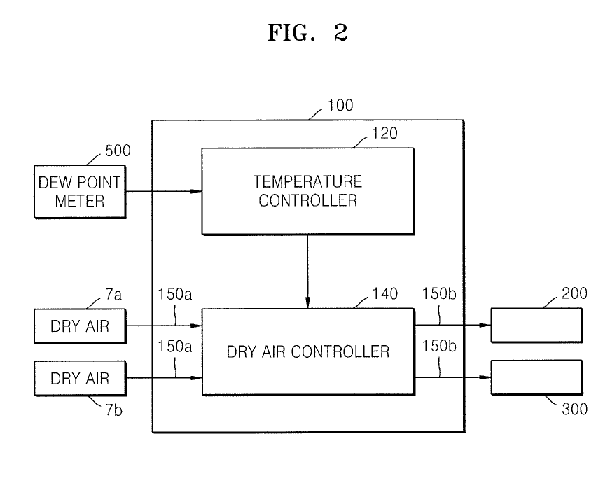

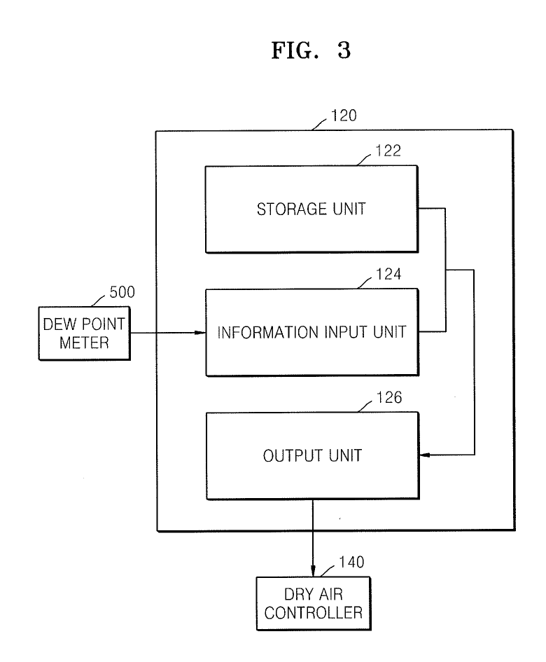

The controller 100 may tunably control an amount of dry air supplied into the prober 200 from an external device. The controller 100 will be described in detail with reference to FIGS. 2 and 3.

The prober 200 performs electrical die sorting (EDS) on a wafer 260 before semiconductor chips fabricated on the wafer 260 are packaged. The prober 200 may include a wafer mounting unit 220, a wafer chuck 240, and a temperature adjustment unit 290.

Dry air is supplied to an inside of the wafer mounting unit 220 via the controller 100. When the wafer 260 is tested at a relatively low temperature, a coolant supplied by the refrigerator 400 is supplied into the prober 200, i.e., the wafer chuck 240, so as to cool the wafer chuck 240. Thus, air in the wafer mounting unit 220 is cooled to a relatively low temperature. In addition, the wafer 260 mounted on the wafer chuck 240 is cooled to a relatively low temperature due to the cooled wafer chuck 240. In this regard, if air in the wafer mounting unit 220 were to leak, it would not be easy to maintain an internal temperature of the wafer mounting unit 220 at a relatively low temperature. Thus, the wafer mounting unit 220 includes a space that is blocked off from the external device.

A lateral door 280 may be installed at a side of the wafer mounting unit 220 facing the loader 300. The wafer 260 may be loaded into or unloaded from the wafer mounting unit 220 via the lateral door 280.

A test head 270 for testing electrical characteristics of the wafer 260 may be installed in an upper portion of the wafer mounting unit 220. When the test head 270 is to electrically test the performance of the semiconductor chips of the wafer 260 mounted on the wafer chuck 240, the test head 270 may descend and contact the wafer 260. When the wafer 260 is not being tested, the test head 270 may be separated from the wafer 260. A probe card having a plurality of probe tips for directly contacting the wafer 260 may be installed at the test head 270.

A test controller (not shown) may be connected to the test head 270. The test controller transmits electrical signals to the wafer 260 via the test head 270, and receives a signal generated in response to the transmission from the wafer 260. Thus, it may be determined whether the semiconductor chips fabricated on the wafer 260 are defective. Semiconductor chips that are determined to be defective based on a result of testing performed by the test controller (not shown) may be removed without undergoing a packaging process.

The wafer chuck 240 may be installed inside the wafer mounting unit 220. The wafer 260 may be mounted on the wafer chuck 240 to be electrically tested. The wafer 260 may be fixed by generating a vacuum on a contact surface between the wafer chuck 240 and the wafer 260 by suctioning air, so that the wafer 260 does not move after the wafer 260 is mounted on the wafer chuck 240.

The temperature adjustment unit 290 may control a temperature of the wafer chuck 240. The temperature adjustment unit 290 may transmit an electrical signal to the refrigerator 400 when the wafer 260 is to be tested at a relatively low temperature. The temperature of the wafer chuck 240 may be decreased by supplying the coolant of the refrigerator 400 to the wafer chuck 240. The internal temperature of the wafer mounting unit 220 may be decreased to a relatively low predetermined temperature as the temperature of the wafer chuck 240 is decreased.

In addition, the temperature adjustment unit 290 may increase the temperature of the wafer chuck 240 when the wafer 260 is to be tested at a relatively high temperature, by operating a heating device (not shown) installed at the wafer chuck 240 after a supply of the coolant from the refrigerator 400 is blocked.

In addition, the temperature adjustment unit 290 may block a supply of the coolant from the refrigerator 400 when the wafer 260 is to be tested at a relatively high temperature, and simultaneously, may stop an operation of the heating device (not shown).

The loader 300 may include a cassette loader 320 and a conveying robot 340. A plurality of wafers may be stacked on a cassette (not shown) which may be loaded into the cassette loader 320. Slots may be formed in the cassette (not shown) at a predetermined pitch so as to prevent damage or an occurrence of particles due to contact between the wafers. The wafers may be put into the slots so that the wafers are stacked on the cassette (not shown) at regular intervals. The conveying robot 340 may load/unload one of the wafers stacked on the cassette (not shown).

The refrigerator 400 stores a coolant, such as, for example, GALDEN™, a fluorinated fluid, and may be connected to the wafer chuck 240 via a host 450. When the wafer 260 is to be tested at a relatively low temperature, the coolant may be supplied to the wafer 260 so that the coolant may be circulated in the wafer chuck 240 via the host 450.

When the wafer 260 is to be tested at a relatively low temperature, if the temperature of the wafer chuck 240 is lower than a dew point of ambient air, dew condensation could occur on the wafer chuck 240 and on a surface of the wafer 260. To prevent this, dry air 7b may be supplied into the prober 200 from the external device via the controller 100 so as to control a dew point in the prober 200. In addition, dry air 7a may be supplied to the loader 300 via the controller 100 from the external device so as to minimize drying of the wafers stacked on the cassette (not shown) and to minimize a variation of the dew point in the prober 200. A flow rate of the dry air 7b supplied into the prober 200 from the external device is controlled by the controller 100, and a flow rate of the dry air 7b supplied from the external device may be measured by using a flow meter 6b. In addition, a flow rate of the dry air 7a supplied to the loader 300 from the external device may be measured by using a flow meter 6a.

A sensor 550 may detect a state of gas generated in the prober 200, and a dew point meter 500 may measure the dew point in the prober 200, that is, a temperature at a time when condensation of the gas detected by the sensor 550 occurs. The sensor 550 may be installed inside or outside the prober 200 and may detect the state of the gas generated in the prober 200.

In addition, the wafer testing apparatus 1 may further include a dehumidifier 600.

The dehumidifier 600 may dehumidify the dry air 7a to be supplied to the loader 300 and the dry air 7b to be supplied to the prober 200 as the dry air 7a and 7b flows into the controller 100 from the external device. That is, dry air with a constant dew point may contain undesired moisture when the dry air is supplied to the controller 100 from the external device. Thus, moisture contained in dry air may be removed by using the dehumidifier 600. Dry air with a uniform dew point and from which moisture has been removed by the dehumidifier 600 may be supplied to the controller 100 and may be provided to the prober 200 or the loader 300.

FIG. 2 illustrates a block diagram of the controller 100 of the wafer testing apparatus 1 illustrated in FIG. 1, and FIG. 3 illustrates a block diagram of a temperature controller 120 of the controller 100 of the wafer testing apparatus 1 illustrated in FIG. 1.

Referring to FIGS. 1 through 3, the controller 100 may include the temperature controller 120 and a dry air controller 140.

The controller 100 may control dry air that is supplied into the prober 200 from an external device.

The temperature controller 120 may compare a first dew point that is set by a user with a second dew point that is measured by the prober 200 using the dew point meter 500. The user may set the first dew point according to a type of a refrigerant used in the refrigerator 400, a temperature at which the wafer 260 is to be tested, a type of the probe card (not shown) attached to the test head 270 for testing the electrical characteristics of the wafer 260, or the like. In addition, the temperature of the wafer chuck 240 in the prober 200 is set to be higher than the first dew point and the second dew point so as to prevent dew condensation on the wafer chuck 240.

The sensor 550 detects a state of gas generated in the prober 200, and the dew point meter 500 measures the second dew point in the prober 200, that is, a temperature at which condensation of the detected gas occurs. In addition, the second dew point is input to the temperature controller 120 of the controller 100 by using the dew point meter 500.

The temperature controller 120 may compare the first dew point set by the user and the second dew point measured in the prober 200 so that it may be determined whether an amount of dry air supplied into the prober 200 is proper.

The temperature controller 120 may include a storage unit 122, an information input unit 124, and an output unit 126.

The storage unit 122 stores the first dew point, which is set by the user. For example, when the user sets the first dew point to −40° C., the storage unit 122 stores this value.

Information regarding the second dew point in the prober 200 is input to the information input unit 124.

The output unit 126 may compare the first dew point stored in the storage unit 122 with the second dew point input by the information input unit 124 and then may output a comparison result to the dry air controller 140. That is, the output unit 126 may compare the first dew point with the second dew point, thereby outputting a comparison result regarding whether the first dew point is equal to the second dew point or is higher or lower than the second dew point, to the dry air controller 140.

The dry air controller 140 may control an amount of dry air supplied into the prober 200 in real time according to a comparison result of the temperature controller 120. For example, the dry air controller 140 may control a flow rate of dry air such that dry air with a flow rate of 100 l/min to 500 l/min may be variably supplied into the prober 200.

The dry air controller 140 may variably control an amount of dry air supplied to the wafer testing apparatus 1, i.e., the prober 200, from the external device according to a comparison result that is output by the output unit 126 of the temperature controller 120.

The first dew point set by the user being higher than the second dew point measured in the prober 200 indicates that an amount of moisture of dry air in the prober 200 is smaller than an amount of moisture according to the first dew point set by the user. Thus, the dry air controller 140 may determine that excess dry air has been supplied into the prober 200 and may control to decrease an amount of dry air supplied into the prober 200. For example, when the first dew point set by the user is −35° C. and the second dew point measured in the prober 200 is −40° C., since the second dew point in the prober 200 is lower than the first dew point set by the user, the dry air controller 140 may control to decrease an amount of dry air supplied into the prober 200.

The first dew point set by the user being lower than the second dew point measured in the prober 200 indicates that an amount of moisture contained in dry air in the prober 200 is greater than a value according to the first dew point set by the user. Thus, the dry air controller 140 may control to increase an amount of dry air supplied into the prober 200 so as to decrease the amount of moisture contained in the prober 200. For example, when the first dew point set by the user is −35° C. and the second dew point measured in the prober 200 is −10° C., since the first dew point set by the user is lower than the second dew point in the prober 200, the dry air controller 140 may decrease the second dew point in the prober 200 by increasing an amount of dry air supplied into the prober 200.

The first dew point set by the user being equal to the second dew point measured in the prober 200 indicates that an amount of moisture contained in dry air in the prober 200 is a user-intended amount. Thus, the dry air controller 140 may control to maintain constant an amount of dry air supplied into the prober 200. For example, when the first dew point set by the user is −35° C. and the second dew point measured in the prober 200 is −35° C., the dry air controller 140 may control to maintain constant an amount of dry air supplied into the prober 200.

As described above, the dry air controller 140 compares the first dew point with the second dew point in the prober 200 to control an amount of dry air supplied into the prober 200. In other implementations, the dry air controller 140 may variably control an amount of dry air supplied into the prober 200 by feeding back the second dew point in the prober 200, which varies based on the amount of dry air supplied in real time, from the dew point meter 500.

In addition, the controller 100 may further include a first pipe portion 150a and a second pipe portion 150b.

The dry air 7a to be directed to the loader 300 and the dry air 7b to be directed to the prober 200 may flow into the controller 100, i.e., the dry air controller 140, via the first pipe portion 150a from the external device. In addition, dry air that is controlled by the dry air controller 140 via the second pipe portion 150b may be supplied into the prober 200. In other implementations, in order to minimize a variation of dew points of the prober 200 and the loader 300, air that is controlled by the dry air controller 140 may be supplied to the loader 300 via the second pipe portion 150b. In this case, in addition to comparing the first dew point set by the user with the second dew point measured in the prober 200 to control an amount of dry air that flows in the prober 200, the dry air controller 140 may also control an amount of dry air that flows in the loader 300 by comparing the first dew point set by the user and a third dew point that is measured in the loader 300. Diameters of the first pipe portion 150a and the second pipe portion 150b may be 0.4 inches to 0.6 inches.

The controller 100 may control an amount of dry air according to a variation of a dew point in the prober 200, by using a proportional integral derivative (PID) control method.

An amount of dry air supplied to the wafer testing apparatus 1 may be minimized by control of the controller 100. Accordingly, an energy cost caused by an oversupply of dry air may be reduced, and an amount of carbon dioxide (CO₂) may be reduced.

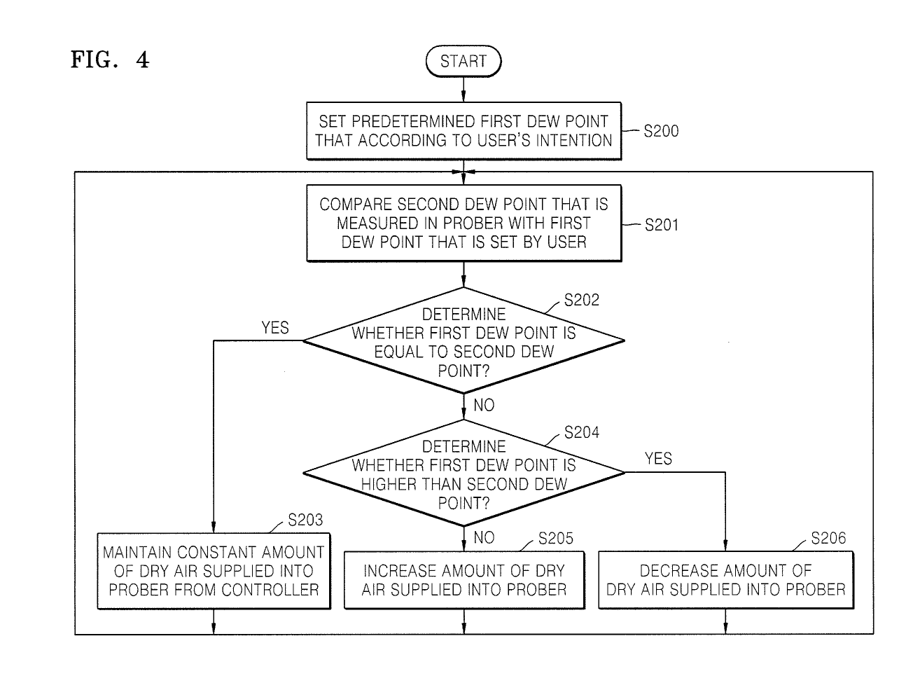

FIG. 4 illustrates a flowchart depicting a method of controlling dry air supplied to the wafer testing apparatus 1 illustrated in FIG. 1 by using the controller 100, according to an exemplary embodiment.

Referring to FIGS. 1 through 4, a predetermined first dew point is set by a user (S200).

Next, a second dew point in the prober 200, in which electrical characteristics of the semiconductor chips of the wafer 260 are tested, is measured using the dew point meter 500 and is compared with the first dew point set by the user (S201).

The prober 200 may include the wafer mounting unit 220, the wafer chuck 240, which is installed in the wafer mounting unit 220 and on which the wafer 260 is mounted, and the temperature adjustment unit 290. The prober 200 may check whether the semiconductor chips are defective by testing the electrical characteristics of the semiconductor chips of the wafer 260 disposed on the wafer chuck 240 at a relatively high temperature, at a relatively low temperature, and at a room temperature.

The first dew point may be set according to a type of a refrigerant used in the refrigerator 400, a temperature for testing the wafer 260, or a type of the probe card (not shown) attached to the test head 270 for testing the electrical characteristics of the wafer 260, or the like.

When the electrical characteristics of the wafer 260 are to be tested, the temperature adjustment unit 290 controls the temperature of the wafer chuck 240, and dry air is supplied into the prober 200 so as to prevent dew condensation on the wafer chuck 240.

The second dew point in the prober 200 is measured and is compared with the first dew point set by the user so that the controller 100 may determine whether an amount of dry air supplied into the prober 200 is proper.

Next, it is determined whether the first dew point set by the user is equal to the second dew point measured in the probe 200 (S202).

When the first dew point is equal to the second dew point, if it is determined by the controller 100 that an amount of dry air supplied into the prober 200 is optimum, the controller 100 controls to maintain constant the amount of dry air supplied into the prober 200 (S203).

However, when the first dew point is not equal to the second dew point, the controller 100 determines whether the first dew point is higher or lower than the second dew point (S204).

That is, when the second dew point measured in the prober 200 is higher than the first dew point set by the user, this indicates that an amount of moisture greater than a user-intended amount of moisture is contained in the prober 200. Accordingly, an amount of dry air supplied into the prober 200 is controlled to be increased so as to decrease the second dew point in the prober 200 to the first dew point (S205). When the amount of dry air supplied into the prober 200 is increased, the second dew point in the prober 200 may be gradually reduced and may become equal to the first dew point set by the user, after a predetermined amount of time. In this regard, when the first dew point has become equal to the second dew point, the controller 100 controls to maintain constant an amount of dry air supplied into the prober 200 to be constant (S203).

When the second dew point measured in the prober 200 is lower than the first dew point set by the user, this indicates that an amount of moisture less than a user-intended amount of moisture is contained in the prober 200. Accordingly, the second dew point in the prober 200 may be increased to the first dew point. Thus, in order to increase the second dew point in the prober 200 to the first dew point, an amount of dry air supplied into the prober 200 is controlled to be decreased (S206). When an amount of dry air supplied into the prober 200 is gradually decreased, the second dew point in the prober 200 is gradually increased and may become equal to the first dew point set by the user, after a predetermined amount of time. In this case, when the first dew point has become equal to the second dew point, the controller 100 controls to maintain constant an amount of dry air supplied into the prober 200 (S203).

The controller 100 may measure the second dew point in the prober 200 in real-time, and compare the second dew point with the first dew point set by the user and variably control the amount of dry air supplied into the prober 200 in real-time. Accordingly, an amount of dry air supplied into the prober 200 may be efficiently decreased, and thus, processing costs may be reduced.

In addition, as above, a method of controlling an amount of dry air supplied into the prober 200 by using the controller 100 has been described. In other implementations, an amount of dry air that is transferred into the prober 200 and is supplied into the loader 300 onto which the wafer 260 is loaded, so as to test the electrical characteristics of the wafer 260, may also be controlled using the same method as the method of controlling an amount of dry air supplied into the prober 200.

A variation of a dew point in the prober 200 may be minimized by supplying dry air to the loader 300, and an amount of dry air supplied to the loader 300 may be efficiently controlled by the controller 100, and thus, the cost for supplying dry air may be reduced and an amount of carbon dioxide (CO₂) may be decreased.

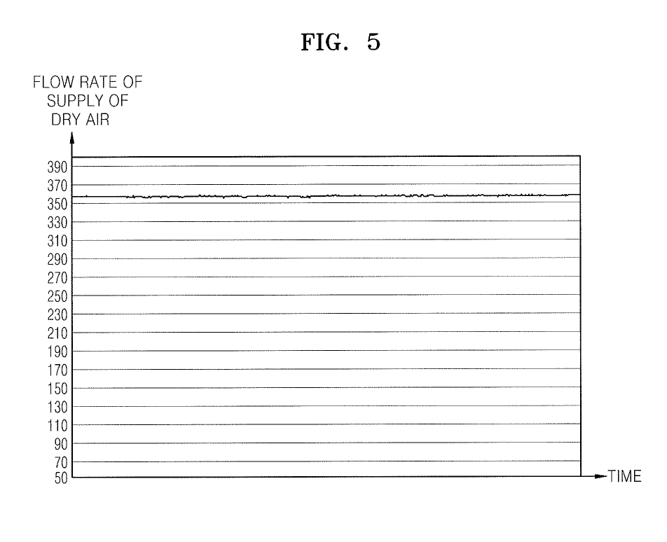

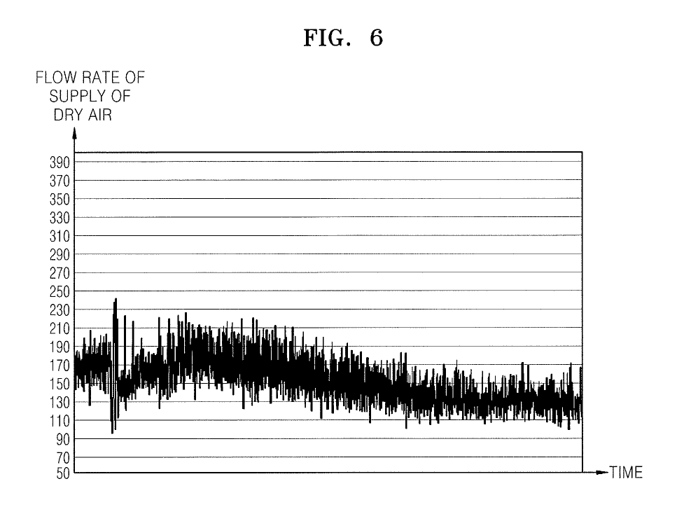

FIG. 5 illustrates a graph showing an amount of dry air supplied to a prober of a wafer testing apparatus that does not include a controller, according to time, and FIG. 6 illustrates a graph showing an amount of dry air supplied to the prober 200 of the wafer testing apparatus illustrated in FIG. 1.

Referring to FIG. 5, an amount of dry air supplied into the prober may be constant. That is, since dry air that flows from an external device is not controlled, even when a dew point lower than a user-intended dew point may be achieved in the prober, excess dry air may be exhausted.

Referring to FIGS. 1 and 6, an amount of dry air supplied into the prober 200 from the controller 100 may be varied in real-time, and a flow rate of dry air less than a flow rate of dry air supplied into the prober 200 may be supplied to the controller 100, as illustrated in FIG. 5. The flow rate of dry air supplied to the controller 100 may be varied using a PID control method in such a way that dry air supplied to the controller 100 maintains the second dew point to be equal to the first dew point set by the user.

Thus, the wafer testing apparatus 1 including the controller 100 does not supply dry air at a constant flow rate into the prober 200 but variably supplies dry air, and a dew point thereof is fed back in real time as the second dew point.

Thus, in the wafer testing apparatus that does not include a controller, dry air with a flow rate of approximately 356 l/min is nearly constantly supplied into the prober 200 from an external device. However, if an amount of dry air supplied into the prober 200 in real-time is controlled by the controller 100, the amount of dry air supplied into the prober 200 may be reduced to an average flow rate of 154 l/min.

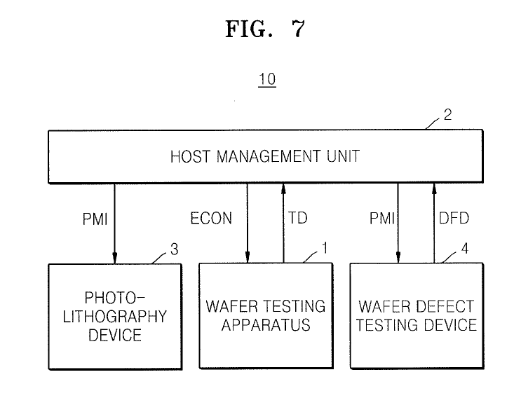

FIG. 7 illustrates a block diagram of a wafer testing system 10 according to an exemplary embodiment.

Referring to FIG. 7, the wafer testing system 10 may include a host management unit 2, a photolithography device 3, a wafer defect testing apparatus 4, and a wafer testing apparatus 1.

The wafer testing system 10 controls a photolithographic process, a wafer defect inspection process, and a process of performing electrical die sorting (EDS) on a wafer and performs a wafer test on a correction center location that is corrected based on photo map information PMI that is used in the photolithographic process, thereby improving a matching rate of defective data.

The host management unit 2 may control the photolithographic process by supplying a photo control signal PCON (not shown) to the photolithography device 3. The photo control signal PCON (not shown) is a base for the photolithographic process and may include the photo map information PMI.

The photolithography device 3 may perform the photolithographic process based on the photo map information PMI.

The wafer defect testing device 4 may perform a wafer test by using the photo map information PMI received from the host management unit 2 during a wafer manufacturing process and may generate defective data DFD regarding semiconductor chips.

The wafer testing apparatus 1 may receive an electrical test control signal ECON from the host management unit 2, and may apply an electrical signal to a wafer and may determine whether semiconductor chips on the wafer are defective, based on the received electrical test control signal ECON. The wafer testing apparatus 1 may have the structure described with reference to FIGS. 1 through 3. In addition, the operation of the wafer testing apparatus 1 may be performed after a wafer line process is completed. The wafer testing apparatus 1 may perform a test to determine whether the semiconductor chips that are formed on the wafer, after analysis of the defective data DFD is performed by the wafer defect testing device 4, are defective. In addition, the wafer testing apparatus 1 may generate test data TD regarding a test result and may provide the test data TD to the host management unit 2.

The host management unit 2 may control the photolithography device 3, the wafer defect testing device 4, and the wafer testing apparatus 1 and thus may use the photo map information PMI used in the photolithographic process, in a process of testing a wafer.

The wafer testing system 10 may receive the defective data DFD regarding the wafer defect testing device 4 and the test data TD of the wafer testing apparatus 1 from the host management unit 2 and may compare the defective data DFD with the test data TD and thus may check a cause of defect of semiconductor chips.

By way of summation and review, the present embodiments provide a semiconductor wafer apparatus in which an amount of supplied dry air is controlled automatically.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A wafer testing apparatus comprising:
a temperature controller for comparing a predetermined first dew point with a second dew point in a prober; and
a dry air controller for controlling an amount of dry air supplied into the prober based on a comparison result of the temperature controller.

2. The wafer testing apparatus as claimed in claim 1, wherein the temperature controller compares the first dew point with the second dew point in real time.

3. The wafer testing apparatus as claimed in claim 1, wherein the temperature controller compares the first dew point with the second dew point in the prober in real time, the second dew point varying based on an amount of dry air controlled by the dry air controller.

4. The wafer testing apparatus as claimed in claim 1, wherein the temperature controller includes:
a storage unit for storing the first dew point;
an information input unit to which the second dew point is input; and
an output unit for comparing the first dew point stored in the storage unit with the second dew point input to the information input unit, and for outputting a comparison result to the dry air controller.

5. The wafer testing apparatus as claimed in claim 1, wherein, the dry air controller is configured such that when the first dew point is higher than the second dew point, the dry air controller controls an amount of dry air supplied into the prober to be decreased.

6. The wafer testing apparatus as claimed in claim 1, wherein, the dry air controller is configured such that when the first dew point is lower than the second dew point, the dry air controller controls an amount of dry air supplied into the prober to be increased.

7. The wafer testing apparatus as claimed in claim 1, wherein, the dry air controller is configured such that when the first dew point is equal to the second dew point, the dry air controller controls to maintain constant an amount of dry air supplied into the prober.

8. The wafer testing apparatus as claimed in claim 1, further comprising:
a first pipe portion through which dry air flows into the dry air controller from an external device; and
a second pipe portion through which dry air is supplied into the prober at an amount controlled by the dry air controller.

9. The wafer testing apparatus as claimed in claim 8, further comprising a dehumidifier for dehumidifying dry air that flows into the dry air controller through the first pipe portion.

10. The wafer testing apparatus as claimed in claim 1, further comprising a dew point meter unit that measures the second dew point, the dew point meter unit being formed inside or outside the prober.

11. A wafer testing apparatus comprising:
a temperature controller for comparing a predetermined first dew point with a second dew point that is measured in a prober or a third dew point that is measured in a loader; and
a dry air controller for controlling an amount of dry air supplied into the prober or the loader based on a comparison result of the temperature controller.

12. The wafer testing apparatus as claimed in claim 11, wherein the temperature controller includes:
a storage unit for storing the first dew point;
an information input unit to which information regarding the second dew point or the third dew point is input; and
an output unit for comparing the first dew point stored in the storage unit, with the second dew point or the third dew point input to the information input unit and outputting a comparison result to the dry air controller.

13. The wafer testing apparatus as claimed in claim 11, wherein, the dry air controller is configured such that when the first dew point is higher than the second dew point, the dry air controller controls an amount of dry air supplied into the prober to be decreased, and when the first dew point is lower than the second dew point, the dry air controller controls the amount of dry air supplied into the prober to be increased, and when the first dew point is equal to the second dew point, the dry air controller controls the amount of dry air supplied into the prober to be constant.

14. The wafer testing apparatus as claimed in claim 11, wherein, the dry air controller is configured such that when the first dew point is higher than the third dew point, the dry air controller controls an amount of dry air supplied to the loader to be decreased, and when the first dew point is lower than the third dew point, the dry air controller controls the amount of dry air supplied to the loader to be increased, and when the first dew point is equal to the second dew point, the dry air controller controls the amount of dry air supplied to the loader to be constant.

15. The wafer testing apparatus as claimed in claim 11, wherein the temperature controller compares the first dew point with the second dew point or the third dew point in real-time.

16. A wafer testing apparatus, comprising:
a testing chamber;
a dew point measuring unit that monitors a dew point inside the testing chamber and provides a measured testing chamber dew point value in real time; and
a controller that controls an amount of dry air supplied into the testing chamber according to the measured testing chamber dew point value.

17. The wafer testing apparatus as claimed in claim 16, wherein the controller stores a predetermined dew point value, compares the predetermined dew point value with the measured testing chamber dew point value to provide a comparison result, and controls the amount of dry air supplied to the testing chamber according to the comparison result.

18. The wafer testing apparatus as claimed in claim 17, wherein the controller controls the amount of dry air supplied to the testing chamber to be decreased when the predetermined dew point value is greater than the measured testing chamber dew point value, to be increased when the predetermined dew point value is less than the measured testing chamber dew point value and to remain constant when the predetermined dew point value equals the measured testing chamber dew point value.

19. The wafer testing apparatus as claimed in claim 17, further including a loading chamber, wherein:
the dew point measuring unit further monitors a dew point inside the loading chamber to provide a measured loading chamber dew point value in real time, and
the controller independently controls an amount of dry air supplied into the loading chamber according to a comparison of the measured loading chamber dew point value with the predetermined dew point value.

20. The wafer testing apparatus as claimed in claim 19, wherein the controller controls the amount of dry air supplied to the loading chamber to be decreased when the predetermined dew point value is greater than the measured test chamber dew point value, to be increased when the predetermined dew point value is less than the measured loading chamber dew point value and to remain constant when the predetermined dew point value equals the measured loading chamber dew point value.
